(19) United States
(12) Patent Application Publication
(10) Pub. No.: US 2018/0258677 A1
(43) Pub. Date: Sep. 13, 2018

(54) Hinge Allowing Opening Along More Than One Axis and Complete Disengagement of Hinge and Removal of Hinged Device

(71) Applicant: Bad Bass Industries, LLC, Elko, NV (US)

(72) Inventor: Cody Bright, Elko, NV (US)

(73) Assignee: Bad Bass Industries, LLC

(21) Appl. No.: 15/671,990

(22) Filed: Aug. 8, 2017

Related U.S. Application Data
(60) Provisional application No. 62/470,134, filed on Mar. 10, 2017.

(51) Int. Cl. E05D 15/50; E05C 1/00; E05C 1/06; E05C 9/00; E05C 9/04; E05C 9/10; E05C 9/18; E05C 17/00; E05D 3/02; E05D 7/10

(52) U.S. Cl. CPC E05D 15/502; E05C 1/006; E05C 1/06; E05C 9/006; E05C 9/04; E05D 7/121; E05C 9/1808; E05C 17/025; E05D 3/02; E05D 7/1005; E05D 2007/1027; E05C 9/10

(57) ABSTRACT

The present invention provides a hinge apparatus for attaching a hinged device, such as a lid or door, to a structure to which the hinged device is to be attached. The hinge apparatus operates using hinge pins operable to selectively engage or disengage between the hinged device and the structure. In a closed position all pins can be engaged between the hinged device and the structure to hold the hinged device in the closed position. When desired to move the device to an open position, the hinge apparatus is operated so the pins on the desired hinge side are engaged between the hinged device and the structure while the pins on the opposite side of the hinged device are disengaged between the hinged device and the structure. This allows the hinged device to be rotated about the selected engaged pins, the engaged pins forming the hinge axis.

### PRIORITY CLAIM

Priority is claimed to copending U.S. Provisional Patent Application Ser. No. 62/470,134 filed Mar. 10, 2017, which is hereby incorporated herein by reference in its entirety.

### BACKGROUND OF THE INVENTION

### Field of Invention

The present invention relates to a hinge that allows a hinged device, and particularly a lid over an opening in a surface, such as the lid over a storage compartment in the deck of a bass fishing boat, to be opened to allow access to the storage compartment.

### State of the Art

Hinges have been designed to attach devices, such as doors or lids, to a structure, such as a door frame, cupboard, or compartment, to allow the hinged devices to rotate or pivot along a single pivot axis, i.e., a single side of the device, with respect to the structure. Once attached to the structure, the hinged device cannot be removed from the structure without disconnection of the hinges via physical removal of the hinges from either the device or the structure. Also, hinges are usually visually and physically exposed.

Hinges pivoting along a single axis are often useful only if a user is positioned along the non-hinged side of the hinged device such that the user is opening the hinged device from the non-hinged side. This can be a problem if a user is positioned on the hinged side of the device because to open such device the user has to either move to the opposite, non-hinged side of the device to open the device, or has to lean over the device to hold the non-hinged side of the device to move the non-hinged side of the device toward the user to rotate the device around the single hinged axis. This can result in situations where it is extremely difficult for a user to rotate the hinged device to open it. This is particularly true when the device is a lid over an opening in a surface, such as the lid over a storage compartment in the deck of a bass fishing boat, to be opened during use to allow access to the storage compartment. If such a lid is to be opened, the user should be positioned on the non-hinged side of the lid in order to be able to lift the non-hinged side of the lid to open the lid. If the user is positioned on the hinged side of the lid, the user has to lean over the lid to hold the non-hinged side to lift the non-hinged side of the lid up and toward the user. This can be very difficult or impossible to do. Therefore, it would be advantageous to be able to open the hinged lid from either opposite side of the lid.

With current hinged devices, it is usually necessary to physically remove the hinges from the device or from the structure the device is hinged to in order to remove the device. Further, access to the hinge fasteners is often difficult and at times near impossible. This makes removal of the hinged device quite labor intensive and time consuming and prohibits the easy direct removal of the hinged device, if removal is desired. For the example of a hinged lid over an open storage compartment in the deck of a bass fishing boat, with the current hinged lids, it is necessary to physically remove the hinges attaching the hinged side of the lid to the deck of the boat from either the lid or the deck of the boat in order to remove the lid from the deck of the boat. This can also be very difficult or impossible to do. Sometimes it would be advantageous to be able to easily completely remove the lid from the deck of the boat.

Currently, hinges are often exposed visually and physically. This presents a problem two fold. First is from decreased visual aesthetics. Second is that the hinges have a tendency to become dirty which leads to decreased functionality.

Therefore, a need exists for a novel hinge design that allows a hinged device to pivot along a selected one of multiple axes. This allows a user to easily move a hinged device from more than one selectable side of the device so the user does not have to position himself or herself on a single non-hinge side of the device for moving the device. Further, a need exists for a hinge which can be easily disengaged, thereby allowing for the device to be completely removed or put back in place easily without having to remove fasteners from the hinge, the device, or the structure.

### SUMMARY OF THE INVENTION

The present invention comprises a novel hinge apparatus for hingedly attaching a hinged device to a structure to which the hinged device is to be attached. The hinge apparatus of the invention operates using hinge pins operable to selectively engage or disengage between the hinged device and the structure. In a closed position all pins can be engaged between the hinged device and the structure to securely hold the hinged device in the closed position. When desired to move the device to an open position, the hinge apparatus is operated so that the pins on the desired hinge side of the hinged device are engaged between the hinged device and the structure while the pins on the opposite side of the hinged device are disengaged between the hinged device and the structure. This allows the hinged device to be rotated about the pins engaged between the hinged device and the structure, the engaged pins forming the hinge axis. The engagement or disengagement of the pins is controlled and selected by a user through a user control which operates the pins to engage or disengage selected pins between the hinged device and the structure. The user control can be in the nature of a user control knob which is operated by a user to rotate a plate or disc, which rotates additional plates or discs which operate in the manner of cams to simultaneously extend pins on one side of the device and retract pin on the opposite side of the device. When the user control is moved in one direction, pins along one hinge axis are engaged with the structure so the device can be rotated around the one hinge axis and opened around that one hinge axis. When the user control is moved in another direction, pins along another hinge axis are engaged with the structure so the device can be rotated around the another hinge axis and opened around that another hinge axis. When all pin are disengaged between the hinged device and the structure, the device is disconnected from the structure and can be completely removed from the structure. Such disengagement of all pins will usually require disengagement of one set of pins and then the disengagement of the other set of pins. The device can be reconnected to the structure by simply placing the hinged device back in its place as prior to removal, and the pins re-engaged with the structure in one of many combinations.

In one embodiment of the invention, the hinged device includes a first set of pins on a first side of the device creating a first hinge axis and a second set of pins on a second side of the device creating a second hinge axis on the opposite side of the device. A user operated control can be operated by a user to selectively extend or retract the sets of pins. With the hinged device positioned to be hingedly attached to the structure to which it is to be hingedly attached, if the user operated control is moved in a first direction to a first position, the pins on the second side of the device are disengaged from the structure and the pins on the first side of the device are engaged with the structure so the device can be rotated with respect to the structure around the first hinge axis. If the user operated control is moved in a second direction, such as the opposite direction, to a second position, the pins on the first side of the device are disengaged from the structure and the pins on the second side of the structure are engaged with the structure so the device can be rotated with respect to the structure around the second hinge axis. With the user operated control in an intermediate position between the first and second positions, the hinged device can be held in closed position with all pins engaged with the structure. Disengaging of both sets of pins allows for removal of the hinged device from the structure. The device can be reconnected to the structure by simply placing the hinged device back in its place as prior to removal, and re-engaging selected pins with the structure.

Depending upon the device to be hinged, the hinge mechanism itself can be physically attached to the hinged device from the underneath position, thus protecting it from the elements and eliminating it from being visually seen. In such case, the only way the hinge mechanism is seen is from underneath the hinged device when the hinged device is opened, or if the hinged device is made from a transparent material. If the hinged device is a lid over an opening in a storage compartment in the deck of a bass fishing boat, the present invention allows the lid to be opened from opposite sides of the lid making access to the storage compartment much easier for a fisherperson on the boat deck. Further, the hinge mechanism can be underneath the lid so is hidden from view when the lid is closed and is protected from weather, water, and people on the deck of the boat.

### BRIEF DESCRIPTION OF THE DRAWINGS

Features and advantages of the invention will be apparent from the detailed description which follows, taken in conjunction with the accompanying drawings, which together illustrate, by way of example, features of particular embodiments of the invention as applied to a lid covering an opening to a storage compartment in the deck of a bass fishing boat, wherein:

FIG. 1 is a pictorial schematic view of a bass type fishing boat showing a plurality of lids over and closing a plurality of storage compartments in the deck of the boat with one lid shown in partially open position with the lid hinged to open with the lid rotating inwardly toward the center of the boat.

FIG. 2 is a pictorial schematic view of the bass type fishing boat of FIG. 1, showing the lid shown in partially open position in FIG. 1 with the lid hinged along the opposite side from that shown in FIG. 1 so that the lid is opened with the lid rotating outwardly toward the side of the boat.

FIG. 3 is a pictorial schematic view of the bass type fishing boat of FIGS. 1 and 2 showing the lid shown in partially open positions in FIGS. 1 and 2 removed from attachment to the boat and showing a lid on the opposite side of the boat in partially open position with the lid hinged to open with the lid rotating inwardly toward the center of the boat as in FIG. 1.

FIG. 4 is a pictorial view showing a lid attached to the deck of a bass type fishing boat to cover an opening to a storage compartment in the deck of the boat and showing the lid in partially open position and showing the hinge apparatus of the invention on the underside of the lid.

FIG. 5 is a pictorial view showing the lid of FIG. 4 attached to the deck of the bass type fishing boat from the top side of the lid and showing the top of the lid as being transparent so the hinge apparatus mounted on the underside of the lid as shown in FIG. 4 is visible through the transparent top of the lid.

FIG. 6 is a further pictorial view showing the left half of the lid of FIG. 4 drawn to a larger scale showing more detail of the mounting of the lid to the deck of the boat.

FIG. 7 is an assembled view of the hinge apparatus of the invention as it would appear assembled on the underside of a lid, such as shown attached to the underside of the lid in FIG. 4, showing the apparatus with all pins in partially extended position as would provide a lid in a locked closed condition.

FIG. 8 is an assembled view of the hinge apparatus of FIG. 7, showing the apparatus with the pins at the top side of the assembled apparatus in a fully extended position and the pins at the bottom side of the assembled apparatus in a fully retracted position as would provide a hinged lid with axis of rotation formed by the top pins.

FIG. 9 is an assembled view of the hinge apparatus of FIG. 7, showing the apparatus with the pins at the top side of the assembled apparatus in a fully retracted position and the pins at the bottom side of the assembled apparatus in a fully extended position as would provide a hinged lid with axis of rotation formed by the bottom pins.

FIG. 10 is a fragmentary detailed pictorial view of the lower left back corner of the lid shown in FIG. 6 showing the lid in partially open condition as shown in FIG. 6.

FIG. 11 is a fragmentary detailed view similar to that of FIG. 10, showing the lid in fully open condition.

FIG. 12 is a fragmentary vertical section through a portion of a pin showing spring bias means to space the lid from the deck.

FIG. 13 is a fragmentary pictorial view showing the left half of an embodiment of a lid of the invention similar to that of FIGS. 4-7 attached to the deck of a bass type fishing boat to cover an opening to a storage compartment in the deck of the boat wherein the deck has a recess around the opening to the storage compartment and the lid is adapted to mount in the recess, and showing the lid in open position and showing the hinge apparatus of the invention on the underside of the lid.

FIG. 14 is a fragmentary detailed pictorial view showing the left corner portion of the lid of FIG. 13 drawn to a larger scale showing more detail of the mounting of the lid to the deck of the boat.

### DETAILED DESCRIPTION OF THE ILLUSTRATED EMBODIMENT

The present invention provides a hinge apparatus for hingedly attaching a hinged device to a structure to which the hinged device is to be attached. The invention allows the hinged device to rotate with respect to the structure to which it is attached along a selected one of more than one selectable axes. This is particularly advantageous for doors such as cupboard or appliance doors and lids such as lids or hatches over openings, such as openings to storage compartments, or any other situation where a hinged device could advantageously be opened or otherwise rotated from selectable sides of the device. The invention will be illustrated and described in detail as applied to a lid for a storage compartment opening in the deck of a bass type fishing boat, to be opened along a side of the lid from a closed position covering, and usually sealing, the storage compartment opening to an open position to allow access to the storage compartment. Hereinafter, reference to a lid as the hinged device will be considered to include any hinged devices, such as a lid, door, or other device.

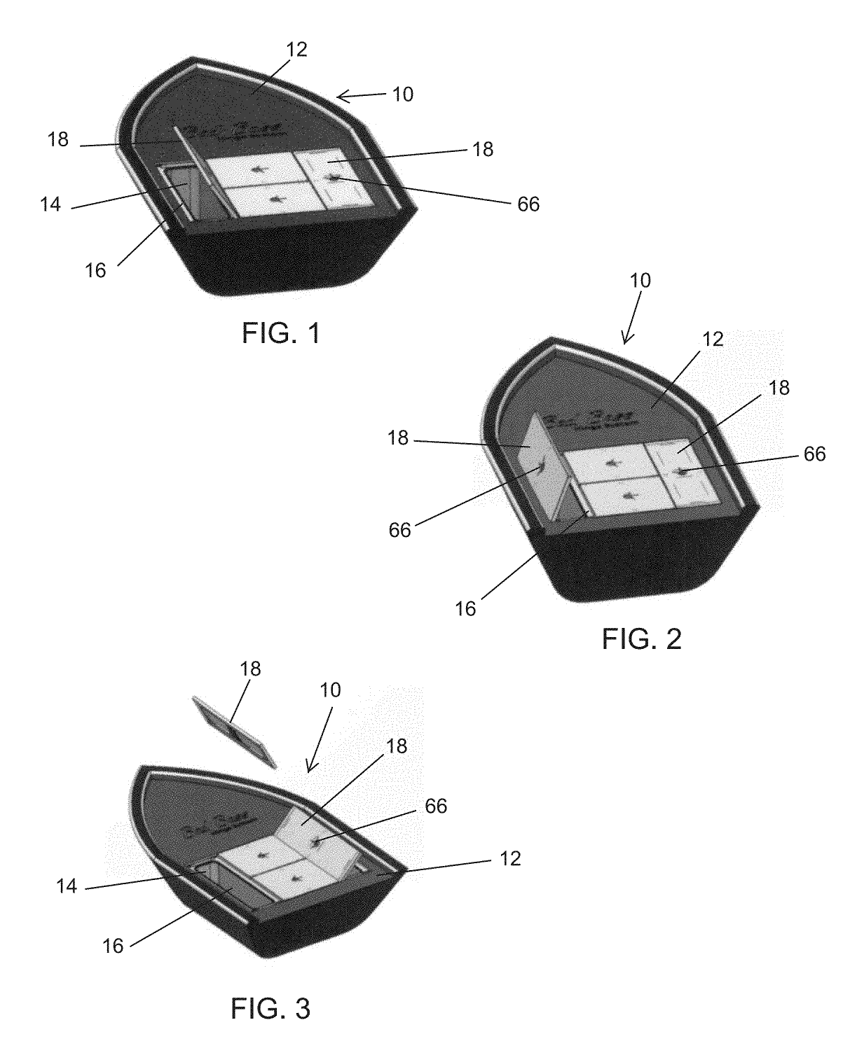

FIGS. 1-3 are schematic representations of a bass type fishing boat 10 having a deck 12 with storage compartments 14 extending through openings 16 through deck 12 and with lids 18 covering the openings 16 into the storage compartments 14. Current bass fishing boats have lids 18 hingedly attached to the deck 12 to open in a single direction, such as with the lids 18 along the sides of the boat opening toward the middle of the boat as shown in FIGS. 1 and 3, or toward the outside of the boat as shown in FIG. 2. In some instances it would be advantageous to be able to open the lids 18 along the opposite sides of the lids, depending upon where the user is positioned in the boat or next to the boat. However, with current boats, the lids are hingedly attached to the boat deck 12 so as to open in only one direction. Further, in some instances, it would be advantageous to be able to completely remove the lids 18 from over the storage compartments 14 and from the deck 12 as shown for one of the lids 18 in FIG. 3. However, with current boats, the lids are not removable without physically disconnecting the hinge apparatus attaching the lid to the deck from either the deck or from the lid. This is usually difficult and time consuming to do. It would be advantageous to be able to easily disconnect the lids from the deck and remove the lids, such as for cleaning the storage compartments 14 or cleaning the deck 12, and to easily reattach the lid to the deck. The hinge apparatus of the invention allows a user to easily select the side of the lid that is hingedly attached to the deck of the boat and to easily change the side of the lid hingedly attached to the deck of the boat depending upon the side of the lid most easily accessible by the user for opening the lid. The user can also easily disconnect the lid from the deck of the boat when desired to completely remove the lid.

The hinge apparatus of the invention includes a plurality of hinge pins that are selectably extended or retracted by a user to engage or disengage structure pin receiving openings in the structure to which the hinged device, such as a lid or door, is to be hingedly attached. Sets of selected hinge pins associated with the hinged device, usually a pair of hinge pins, can be extended to engage a corresponding set of structure pin receiving openings so that the engaged hinge pins attach the lid to the structure and establish an axis around which the lid can be rotated between positions, such as open and closed positions, with respect to the structure. Different sets of hinge pins and corresponding sets of structure pin receiving openings can be positioned with respect to the hinged device and the structure so that different axes of rotation can be established depending upon which set of hinge pins and corresponding set of structure pin receiving openings are selected. Where sets of hinge pins and corresponding sets of structure pin receiving openings are positioned with respect to the hinged device and the structure so that axes of rotation can be established along opposite sides of the hinged device, a user can select and can change the side of the hinged device from which the hinged device can be opened, by selecting the particular sets of hinge pins which are extended.

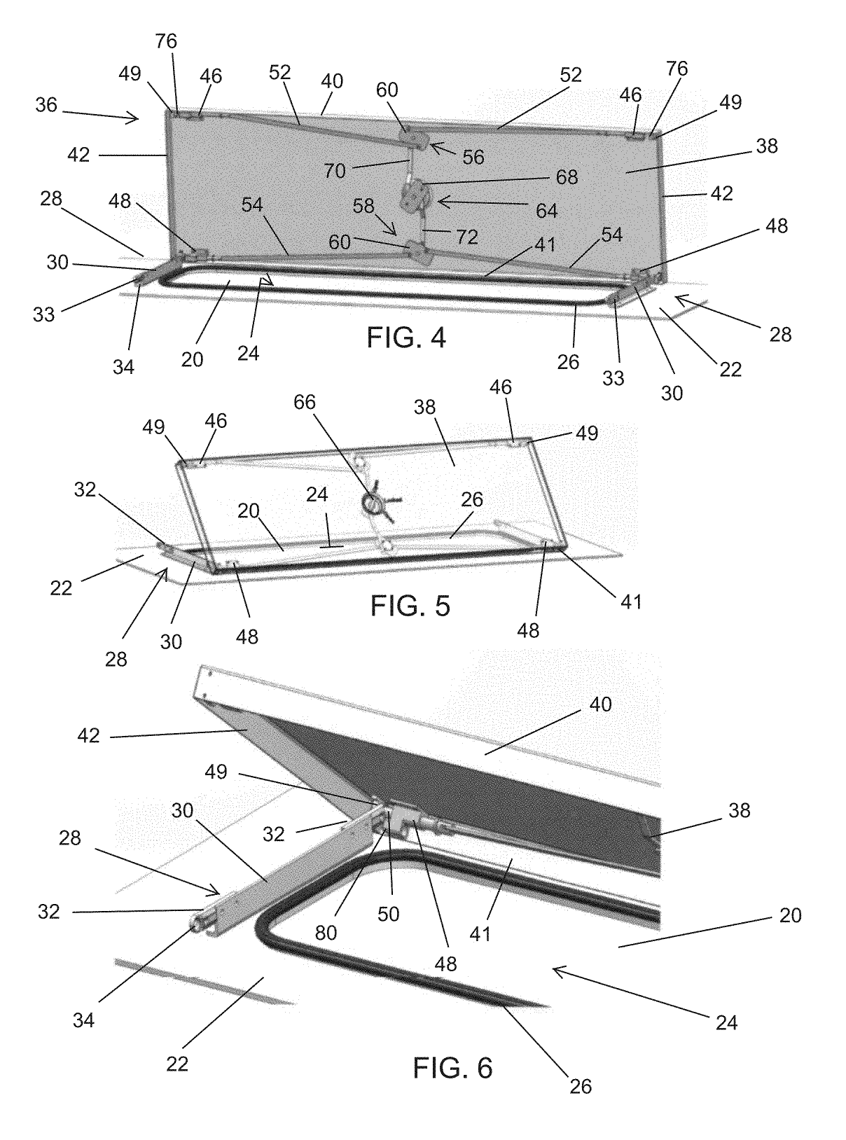

When the hinge apparatus is used with a hinged device of the illustrated embodiments, which is a lid over an opening in a storage compartment in the deck of a bass fishing boat, the deck surface immediately surrounding the opening to be covered and to which the lid is hinged may be flat and flush with the opening to be covered. In such a situation, as shown in FIGS. 4-6, it is necessary to attach hinge pin brackets to the deck at opposite ends of the opening to be covered to provide the structure pin receiving openings to receive and hold the extended hinge pins and secure them and the lid to the structure, i.e., the boat deck. As shown in FIGS. 4-6, an opening 20 opens through deck 22 into a storage compartment 24. A strip of resilient waterproofing material 26 is secured to deck 22 around opening 20. Hinge pin brackets 28 are secured to deck 22 at opposite ends of opening 20. In the illustrated embodiment, hinge pin brackets 28 are formed of an angle iron portion 30 secured to deck 22, with hinge pin bracket end extensions 32 secured to and extending from opposite ends of the angle iron portions 30 of the hinge pin brackets 28. Hinge pin receiving openings 34 are provided in the outer ends of hinge pin bracket end extensions 32 and form the structure pin receiving openings. Hinge pin bracket end extensions 32 may be adjustably secured to angle iron portion 30 so that the distance they extend from the ends of the angle iron portion 30 can be adjusted.

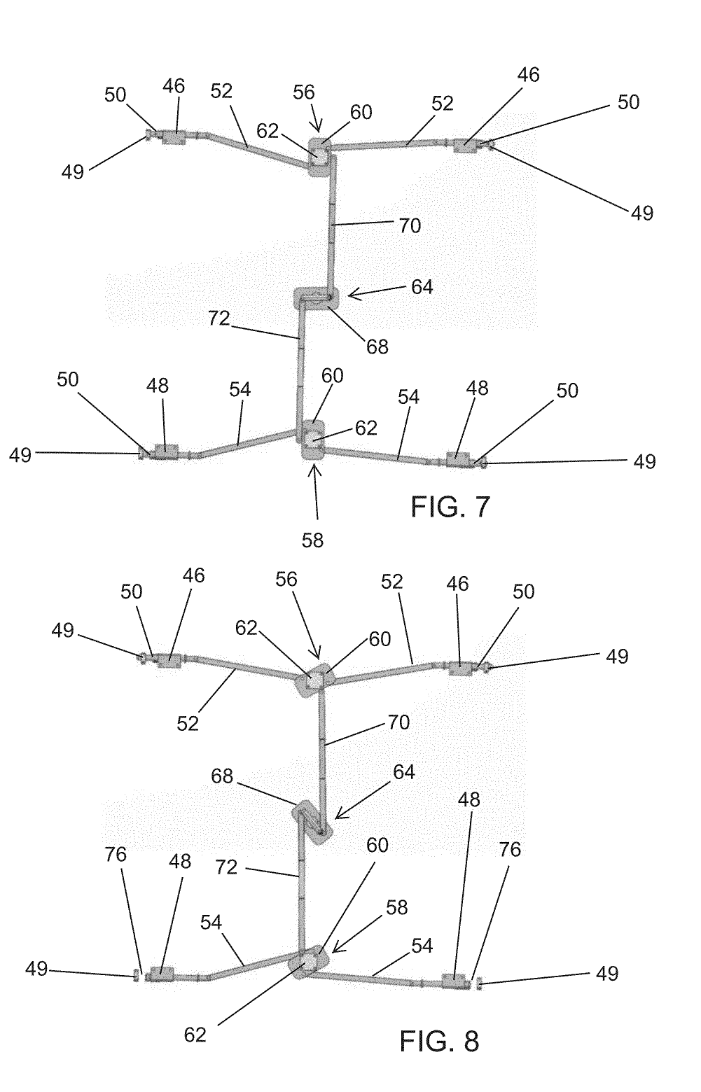

A storage compartment lid 36 having a top 38, FIGS. 4-6, opposite side walls 40 and 41, side wall 40 being the upper side wall as shown in FIGS. 4-6 and side wall 41 being the lower side wall as shown in FIGS. 4-6, and opposite end walls 42, includes hinge apparatus of the invention mounted on the underside thereof. FIG. 5 shows the top 38 as transparent so the hinge apparatus on the underside is visible through the top. The particular illustrated embodiment of the hinge apparatus includes a pair of hinge pin housings 46 secured to the underside of the top 38 of lid 36 at opposite ends of the upper side 40 of the lid as show in FIGS. 4-6 and a pair of hinge pin housings 48 secured to the underside of the top 38 of lid 36 at opposite ends of the lower side 41 of the lid as shown in FIGS. 4-6. Outer pin end receivers 49 are attached to the underside of the top 38 of lid 36 aligned with and spaced outwardly from the outer ends of respective hinge pin housings 46 and 48. FIGS. 7-9 show the hinge apparatus positioned as it would be on the underside of the top 38 of the lid 36 shown in FIGS. 4-6, basically as shown in FIG. 4, but without the lid shown to more clearly show the hinge apparatus and its operation. It should be noted that the proportions of the lids and hinge apparatus in FIGS. 4-6 are different than the proportions of the hinge apparatus in FIGS. 7-9 with the opposite sides, upper and lower sides in FIGS. 4-6, being longer than such sides in FIGS. 7-9, and the opposite ends, left and right in FIGS. 4-6, being shorter than such sides in FIGS. 7-9. The layout of the hinge apparatus is the same in FIGS. 4-6 as in FIGS. 7-9 but the lengths of the respective linkages are different.

Each of the hinge pin housings 46 and 48 slidably house a hinge pin 50 therein so that the hinge pin can be slid to extend from the outer end of the hinge pin housing or slid to be retracted into the hinge pin housing so as not to extend, or extend as far, from the outer end of the hinge pin housing. Pin linkage, shown here as pin linkage rods 52 with one end of each pin linkage rod 52 attached to a respective hinge pin in hinge pin housings 46, and pin linkage rods 54 with one end of each pin linkage rod 54 attached to a respective hinge pin in hinge pin housings 48, is associated with each of the hinge pins by which each of the hinge pins can be slid within their respective hinge housing. The opposite ends of the pin linkage rods 52 and 54 are attached to operating linkage which can move the pin linkage rods to slide the hinge pins within the respective hinge pin housings. Thus, pin linkage rods 52 are each attached to operating linkage 56 and pin linkage rods 54 are each attached to operating linkage 58. Each of the operating linkages 56 and 58 include plates 60 rotatably mounted by fastener 62 on the underside of the top 38 of the lid 36. Rotation of a plate 60 in one direction causes extension of the hinge pins connected to the pin linkage rods from that plate to extend from the hinge pin housings while rotation of the plate 60 in the opposite direction causes retraction of the hinge pins connected to the pin linkage rods from that plate to retract into the hinge pin housings. Plates 60 act as cams in moving linkage rods 52 and 54, and thereby hinge pins 50, as the plates rotate.

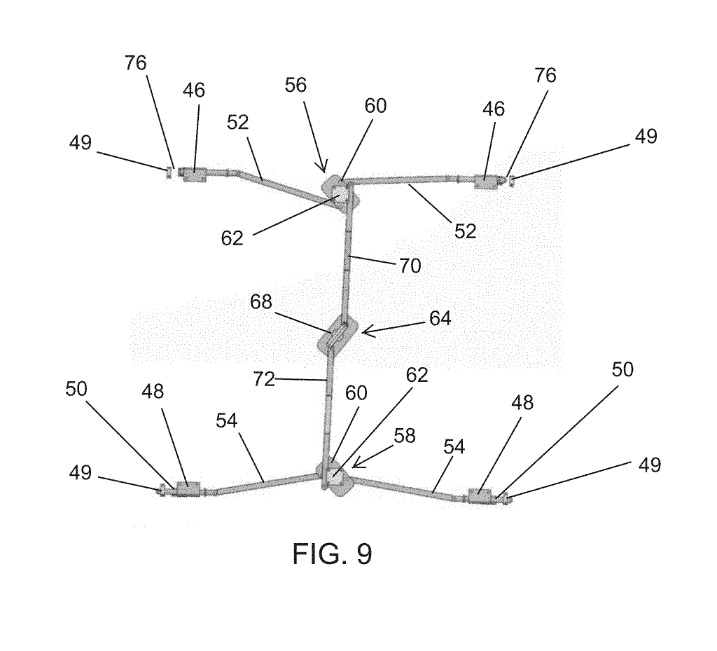

A user operated linkage connects a user selector 64, including a rotatable user control knob 66 recessed in the top 38 of the lid 36, FIGS. 5 and 1-3, to each of the operating linkages 56 and 58. In the illustrated embodiment, the user operated linkage connecting the rotatable user control knob 66 with the operating linkages 56 and 58, is a plate 68 positioned on the underside of the top 38 of lid 36 attached to user control knob 66 to rotate with user control knob 66, and linkage rods 70 and 72 connecting plate 68 to respective plates 60 of operating linkages 56 and 58. The connection of linkage rods 70 and 72 from connecting plate 68 to respective plates 60 of operating linkages 56 and 58 is such that when the user control knob 66 is rotated in one direction, the hinge pins 50 associated with hinge pin housings 46 will move to an extended position with respect to hinge pin housings 46 while the hinge pins 50 associated with hinge pin housings 48 will simultaneously move to a retracted position with respect to hinge pin housings 48. Rotation of the user control knob 66 in the opposite direction will have the opposite results. Plate 68, similarly to plates 60, acts as a cam in moving linkage rods 70 and 72. With the user control knob 66 in an intermediate position, the hinge pins associated with both hinge pin housings 46 and 48 will be partially extended with respect to such hinge pin housings. The outer pin end receivers 49 secured to the underside of the top 38 of lid 36 and spaced from and aligned with respective associated hinge pin housings 46 and 48 are positioned so that when the hinge pins 50 are fully extended from their associated hinge pin housings, the outer ends of such fully extended hinge pins will be received in the associated outer pin end receivers 49. Outer pin end receivers 49 are not required as part of the hinge apparatus, but stabilize the ends of the hinge pins when in fully extended position thereby reducing the forces on the hinge pin housings during rotation of the lid. FIG. 7 shows plate 68 of the user control 64 in the middle intermediate position with all of the hinge pins 50 partially extended from their respective hinge pin housings 46 and 48 toward outer pin end receivers 49, however, in this middle intermediate position, the hinge pins 50 may or may not extended into the outer pin end receivers 49. FIG. 8 shows plate 68 of the user control 64 in a fully clockwise rotated position with hinge pins 50 extending fully from the upper side hinge pin housings 46 into the associated outer pin end receivers 49, and shown as extending through such outer pin end receivers 49, and with hinge pins 50 retracted fully into lower side hinge pin housings 48 leaving an open space 76 between each lower side hinge pin housing 48 and the associated outer pin end receiver 49. FIG. 9 shows plate 68 of the user control 64 in a fully counterclockwise rotated position with hinge pins 50 in fully extended positions from pin lower side hinge pin housings 48 into and through the associated outer pin end receivers 49 and with hinge pins 50 in fully retracted positions into upper side hinge pin housings 46 leaving an open space 76 between each upper side hinge pin housing 46 and the associated outer pin end receiver 49. The open spaces 76 between the hinge pin housings 46 and 48 and their associated outer pin end receivers 49 are adapted to receive the hinge pin bracket end extensions 32 of the hinge pin brackets 28 therein so that selected hinge pins 50 can be extended through structure pin receiving openings 34 of the hinge pin brackets 28 to, when extended through structure pin receiving openings 34, attach the lid to the boat deck.

To attach a storage compartment lid 36 to a boat in position to be closed over a storage compartment opening 20, the user rotates the user control knob 66 to a fully rotated position, such as a full clockwise rotated position as shown in FIG. 8, to leave open spaces 76 between lower side hinge pin housings 48 and the associated outer pin end receivers 49. The lid 36 is then maneuvered to a side of opening 20 such as shown in FIGS. 4-7 and positioned so that the hinge pin bracket end extensions 32 at the back of the hinge pin brackets 28 as shown in FIG. 4 can be inserted into the open spaces 76 with the structure pin receiving openings 34 in those hinge pin bracket end extensions 32 aligned to receive hinge pins 50 when extended from hinge pin housings 48. When so aligned, the user rotates the user control knob so as to cause hinge pins 50 to extend from the lower side hinge pin housings 48 into the structure pin receiving openings 34 in the hinge pin bracket end extensions 32 at the back of the hinge pin brackets 28. This can be a rotation of the user control knob 66 to an intermediate position such as shown in FIG. 7 or to the fully counterclockwise rotated position as shown in FIGS. 4 and 9. With the hinge pins 50 received in the structure pin receiving openings 34 in the hinge pin bracket end extensions 32 at the back of the hinge pin brackets 28, the lid is secured along its lower side 41 to the deck 12 through hinge pin brackets 28 attached to the deck. If the user control knob 66 has been rotated to the fully counterclockwise rotated position as shown in FIGS. 4 and 9, thereby providing open spaces 76 between upper side hinge pin housings 46 and associated outer pin end receivers 49, the lid can be rotated about hinge pins 50 extended along the lower side 41 to a completely closed position over deck opening 20 wherein the hinge pin bracket end extensions 32 at the front of the hinge pin brackets 28 are received in open spaces 76 between the upper side hinge pin housings 46 and the associated outer pin end receivers 49. The lid is now in a closed position. If the user control knob 66 remains in this user selected position so that the hinge pins 50 along the side 40 of the lid remain in fully retracted positions, open spaces 76 remain between upper side hinge pin housings 46 and associated outer pin end receivers 49, and the lid 36 can be rotated when desired by a user between closed and open positions about now hinged side 41 of the lid.

Rather than maneuvering the lid at an angle to attach it to the deck, the lid 36 can be positioned over the opening 20 resting on hinge pin bracket 28. The lid 36 can then be attached to the boat deck by rotating the user control knob 66 so that the hinge pins along one side of the lid are completely retracted and pushing that side of the lid downwardly (or that side of the lid may fall by gravity downwardly) so that the hinge pin bracket end extensions on that side are positioned in the open spaces 76. The user control knob 66 is then rotated so that the hinge pins on that side of the lid are completely extended through the structure pin receiving openings through the hinge pin bracket end extensions under that side of the lid while the hinge pins on the opposite side of the lid become completely retracted. That opposite side of the lid can then be pushed downwardly (or that opposite side of the lid may fall by gravity downwardly) so that the hinge pin bracket end extensions on that opposite side are positioned in the open spaces 76. The user control knob may remain in that setting which will leave the lid rotatably attached to the boat on that side or the user control knob can be operated to lock the lid in closed position or change the axis of rotation to the opposite side of the lid.

If, when lid 36 is in the closed position, the user control knob 66 and plate 64 is rotated to an intermediate position such as the middle intermediate position shown in FIG. 7, hinge pins 50 will be partially extended from upper side hinge pin housings 48 along lid side 40 and will move into pin receiving openings 34 in the hinge pin bracket end extensions 32 at the front of the hinge pin brackets 28, while the hinge pins 50 in the lower hinge pin housings 48 will be partially retracted along lid side 41, but still remain in the pin receiving openings 34 in the hinge pin bracket end extensions 32 at the back of the hinge pin brackets 28, and the lid will be locked in closed position over storage compartment opening 16. In such position, if resilient waterproofing material 26 is present between the lid and the deck, a waterproof seal over the top of the opening 20 can be obtained in this closed position of the lid 36 and the lid 36 will be held in the closed condition.

If, when lid 36 is in the closed position, the user control knob 66 and plate 64 is rotated to the fully clockwise rotated position as shown in FIG. 8, thereby causing hinge pins 50 associated with upper side hinge pin housings 46 to move along lid side 40 to a fully extended position and causing hinge pins 50 associated with lower side hinge pin housings 48 to move along lid side 41 to a fully retracted position as shown in FIG. 8 and out of structure pin receiving openings 34 in the hinge pin bracket end extensions 32 at the back of the hinge pin brackets 28, lid side 41 of lid 36 is now free to be lifted and lid 36 can be rotated about hinge pins 50 extended along the lower side 41 of the lid 36. As can be seen, when the user operated control is rotated between fully clockwise rotated and fully counterclockwise rotated positions, the side of the lid that is rotatably attached to the boat is changed, thereby changing the side of the lid by which a user can lift and open the lid. If a user is on one side of the lid and desires to open the lid from that side, i.e., desires that the lid be rotatably attached to the boat on the opposite side of the lid, the user rotates the user control knob to release the hinge pins on that side of the lid and to engage the hinge pins on the opposite side of the lid so the user can easily open the lid from the side of the lid that the user is on or which is otherwise most convenient for the user to lift to open.

If a user desires to completely detach a lid from the deck of the boat, the user can open or partially open (lift the side of the lid opposite the side that is hinged to the boat so the hinge pins on that side of the lid are above the hinge pin bracket), and then rotate the user operated control knob 66 to an intermediate position where the pins 50 on the side opposite the hinged side of the lid will extend into the open space 76 to prevent the hinge pin bracket end extensions on that side of the hinge pin bracket from entering that space. That side of the lid is then moved toward closed position but the hinge pins filling the open spaces 76 on that side will prevent the hinge pin bracket end extensions from entering the space so the hinge pins will rest on top of the hinge pin bracket end extensions on that side which prevents the lid from completely closing on that side. The user operated control knob is the rotated to completely retract the hinge pins on the hinged side of the lid, which will then release the hinge pins from the structure pin receiving openings through the hinge pin bracket end extensions and the lid can be completely removed from the hinge pin bracket and the boat. To reattach the lid to the hinge pin bracket and the boat, the lid is placed over the storage compartment opening and the side of the lid with the open spaces 76 is positioned so the hinge pin bracket end extensions extend into the open spaces on that side of the lid and the user operated control knob is rotated to move the hinge pins on that side of the lid into the structure pin receiving openings through the hinge pin bracket end extensions on that side of the lid to hingedly attach the lid to the hinge pin brackets and the boat on that side of the lid. Once reattached, the lid can be operated as described above to be opened and closed along user selected sides of the lid or locked in closed position.

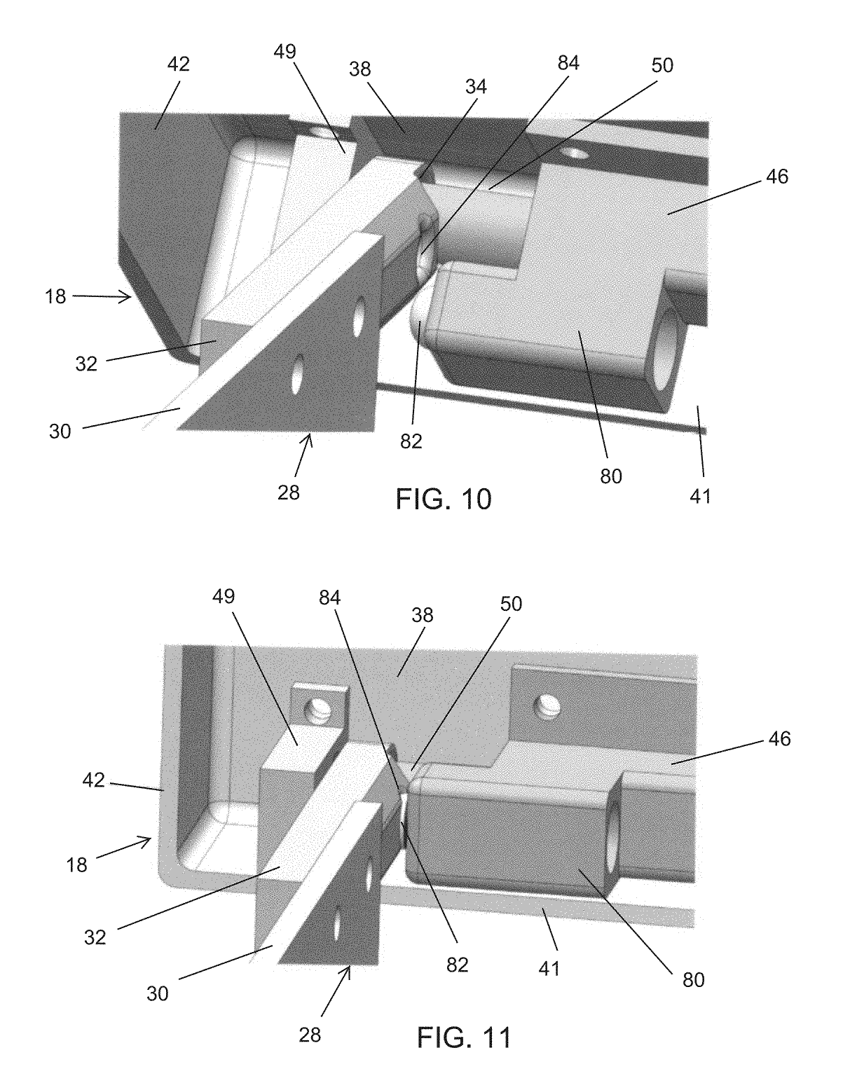

In many instances, it will be desirable to be able to hold the lid in a fully open position once fully opened to allow easy access to the then opened storage compartment. This may be done in various ways, such as by providing a spring loaded ball plunger, which, upon opening the lid will engage with a mating depression in the hinge pin bracket to hold the lid in open position until a user moves the lid against the spring bias from the open position. As shown in FIGS. 6, 10 and 11, hinge pin housings 46 and 48, a hinge pin housing 48 being shown in FIGS. 10 and 11, include a plunger housing 80 with a spring loaded ball plunger 82 extending therefrom. Hinge pin bracket end extension 32 extending from angle iron portion 30 of the hinge pin bracket 28 includes a depression 84 positioned to mate with spring loaded ball plunger 82 when the lid 18 is in fully open position as shown in FIG. 11. Upon opening lid 18, ball plunger 82 extending from ball plunger housing 80 will move toward hinge pin bracket end extension 32, FIG. 10, until lid 16 is close to fully open. As lid 16 moves to its fully open position, ball plunger 82 is pushed into ball plunger housing 80 by hinge pin bracket end extension 32 as the ball plunger moves to a position to extend from housing 80 to engage with mating depression 84 in the hinge pin bracket end extension 32. The ball plunger 82 will remain engaged with mating depression 84 to hold the lid in fully open position until a user moves the lid toward closed position to push the ball against the bias of the spring holding the ball extended to allow the lid to move to closed position. If desired, additional mating depressions can be provided along the path of travel of the ball plunger to hold the lid in one or more intermediate positions between closed and fully open positions.

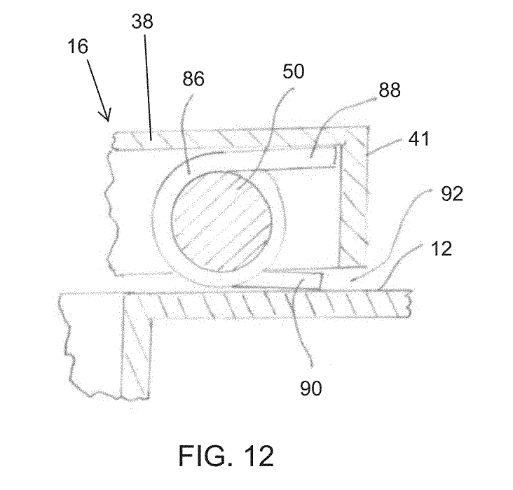

In some applications of the invention where a lid may be configured and mounted so it is difficult to grab to move to an open position, it may be advantageous to provide a means to slightly open the side of the lid opposite the hinged side to allow a user to more easily grab the side of the lid to be opened to lift and begin rotation of the lid from a closed position. In such an application, means can be provided to bias the non-hinged side of the lid to a slightly open position when the lid is not lock in a closed position. Such a bias can be provided in many ways. An example of such a bias means is shown in FIG. 12, wherein a spring 86 can be mounted around a portion of a hinge pin 50 or the linkage from the hinge pin 50 and positioned so that spring ends 88 and 90 will bias the lid 16 away from the surface of the boat deck 12 to which the lid is hinged so that upon release of the hinge pins on the non-hinged side of the lid, that side of the lid is biased slightly away from the surface of the deck and spaced as at 92 to make it easier for a user to grasp and open that side of the lid. Various other spring or biasing arrangements can be used.

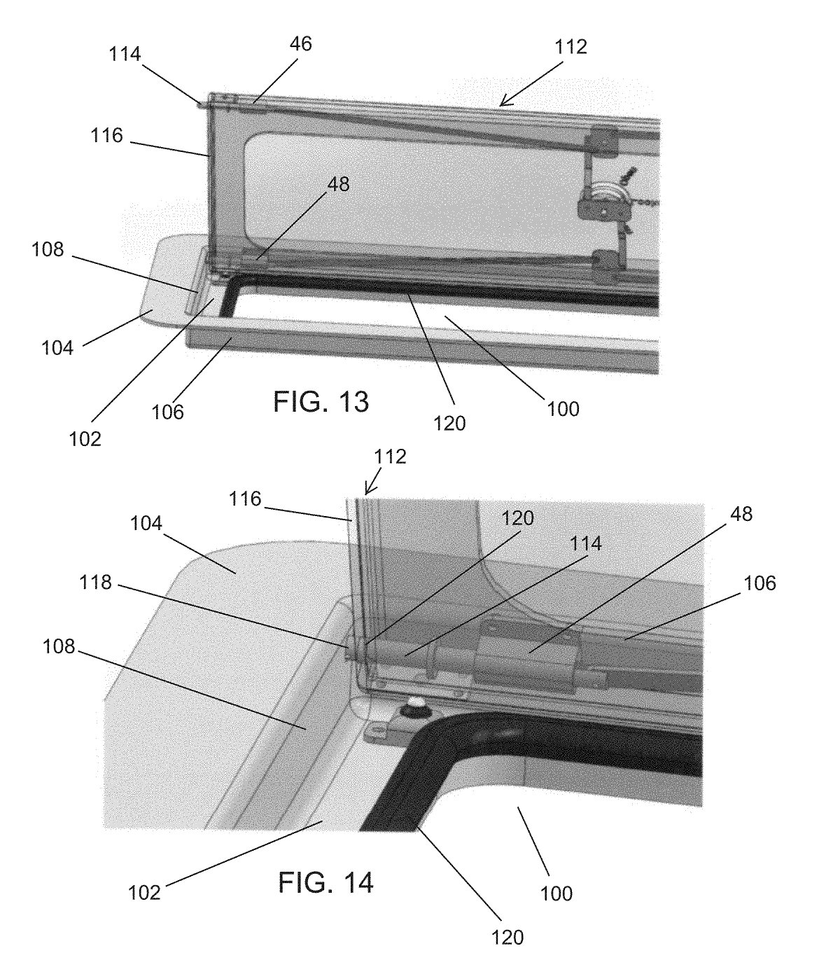

In many instances, rather than the deck surface immediately surrounding the opening to be covered and to which the lid is hinged being flat and flush with the opening to be covered, the opening to be covered is recessed into the deck or other structure to which the hinged device is to be attached. While hinge pin brackets as previously described can be used and mounted in the bottom of the recess at ends of the opening in the recess to be covered or to the deck along opposite ends of the recess itself so the lid can be mounted to the hinge pin brackets as previously described, the end walls of the recess itself can be configured to include the structure pin receiving openings so the hinge pins can be extended directly into the end walls of the recess to rotatably attach the lid to the boat. FIGS. 13 and 14 show a storage compartment opening 100 surrounded by a recessed portion 102 of a deck 104. The recessed portion 102 of the deck may be built into and be an integral portion of the deck or may be formed by an insert mounted in a larger opening in the deck. The recess is formed by opposite recess side walls 106 and opposite recess end walls 108, although only about half of the recess is shown in FIG. 13, the other half will generally be the mirror image of that shown in FIG. 13. An enlarged corner portion of the recess is shown in FIG. 14. FIGS. 13 and 14 show an embodiment of a lid 112 of the invention positioned in the recess 102 over opening 100 and attached to the boat by hinge pins 114 that can be extended from the opposite ends 116 of the lid to be received in structure pin receiving openings 118 in the end walls 108 of the recess.

Lid 112 and the hinge apparatus mounted on the underside of lid 112 is similar to lid 18 and the hinge apparatus mounted on the underside of lid 18 as previously described. However, while lid 18 as illustrated in FIGS. 4-6 is attached to the hinge pin brackets 28 received within the opposite side walls and opposite end walls of the lid 18 so all of the hinge apparatus including the hinge pins 50 in all positions is mounted within the walls of the lid 18, the hinge pins 114 of the embodiment of FIGS. 13 and 14 extend from hinge pin housings 46 and 48 through lid hinge pin openings 120 at opposite sides of each end 116 of lid 112, to outside the ends of the lid 112. In the fully retracted position, the ends of hinge pins 114 extend from hinge pin housings 46 and 48 into and are held in lid hinge pin openings 120 in lid end walls 116. When in extended positions, such as the middle intermediate position as shown in FIG. 13, hinge pins 114 extend from the hinge pin housings 46 and 48, into and through lid hinge pin openings 120 in lid end walls 116, and extend outwardly from lid end walls 116, as shown in FIG. 13 for the end of the pin 114 extending from pin housing 46 at the top side of the lid end 116. In this middle intermediate position, the end of pin 114 extending from hinge pin housing 48 at the lower side of lid 112 extends through lid end wall 116 and into structure hinge pin receiving openings 118 in the end wall 108 of the recess as also shown in FIG. 14. Extension and retraction of the hinge pins are controlled by the user control as previously described, and operation of the lid is as previously described. Thus, when hinge pins on the lower side of lid 112 are extended into structure hinge pin receiving openings 118 in the end walls 108 of the recess as shown in FIG. 14 and hinge pins on the upper side of lid 112 are fully retracted so do not extend into structure pin receiving openings 118 in the end walls 108 of the recess, the lid is hingedly attached to the recess end walls 108 and can be opened by rotating the lid on the axis along the lower side of lid 112 formed by the extended hinge pins at the lower sides of lid ends 116. If the positions of the hinge pins are changed by a user so that the hinge pins on the upper side of lid 112 are extended into structure pin receiving openings 118 in the end walls 108 of the recess and the hinge pins on the lower side of lid 112 are fully retracted so do not extend into structure pin receiving openings 118 in the end walls 108 of the recess, the lid is hingedly attached to the recess end walls 108 and can be opened by rotating the lid on the axis along the upper side of lid 112 formed by the extended hinge pins at the upper sides of lid ends 116. If lid 112 is in the closed position over opening 100 and all hinge pins are in the middle intermediate position so all hinge pins are partially extended to extend into structure pin receiving openings 118 in the end walls 108 of the recess end walls 108, the lid is locked in closed position. A strip of resilient waterproofing material 120 can be provided to seal the lid around the opening 100. If it is desired to remove the lid 112, the hinge pins are operated so the lid can be rotatably opened along one side, and when that side is opened to an extent that the hinge pins on the open side are above the recess end walls, those pins hinge can be fully extended without being received in structure pin receiving openings 118, while the hinge pins along the opposite side of the lid are retracted out of structure pin receiving openings 118. The lid 112 can then be lifted out of the recess and removed. The process is reversed to reattach the lid 112.

While the drawings show the user control of the hinge device in the center of the hinged device, the user control of the hinge devices can be placed anywhere on the hinged device from the true center position illustrated all the way to the outside perimeter by adjusting linkage arm lengths and cam attachment points. Also, multiple user controls can be provided, such as adjacent two sides of the lid so as to be easily accessed by a user. Further, the hinge apparatus can be configured to fit various sizes and shapes of lids by adjusting the linkages and placements of the various parts of the apparatus. In addition, while the illustrated embodiments show pairs of hinge pin housings to establish the axes of rotation for a lid, with large lids it may be necessary or desirable to provide more than two hinge points for each axis of rotation. In such instances intermediate hinge points along an axis may need to be established with additional hinge pin housings, hinge pins, and structure pin receiving openings along with additional pin linkage to operate the additional hinge pins.

While pin linkage rods are shown linking the hinge pins to the various operating linkages, various other types of linkages can be used such as cables. If flexible linkages, such as flexible cables are used, the hinge pins will generally need to be biased to either a fully extended or fully retracted position in the hinge pin housings so the user control will move the hinge pins against the bias to one position, such as the fully retracted position, and hold the hinge pins in that position against the bias as long as desired in that position, or will release the hinge pins from that held position to allow the hinge pins to move to the biased position, such as the extended position.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A hinged lid for an opening in a structure, comprising:
a lid body having first and second opposite sides and opposite ends, each opposite end having a corresponding first side and corresponding second side;
a hinge pin associated with each respective opposite side of the opposite ends of the lid body extendable and retractable with respect to the opposite ends, and adapted to cooperate with a structure pin receiving opening associated with the structure wherein a hinge pin in extended position can extend into and be rotatably held by the structure pin receiving opening;
linkage associated with each of said respective hinge pins by which the respective hinge pins can be extended or retracted with respect to the opposite ends; and
user operated linkage control by which the user can selectively extend or retract respective hinge pins.

2. A hinged lid for an opening in a structure, according to claim 1, wherein the linkage associated with each of said respective hinge pins by which the respective hinge pins can be extended or retracted with respect to the opposite ends includes:
pin linkage associated with each of said respective hinge pins by which the respective hinge pins can be extended or retracted with respect to the opposite ends;
a first operating cam attached to the lid and attaching the pin linkage associated with the respective hinge pins associated with the first side of the lid by which the respective hinge pins associated with the first side of the lid can be simultaneously extended or retracted with respect to the opposite ends of the lid;
a second operating cam attached to the lid and attaching the pin linkage associated with the respective hinge pins associated with the second side of the lid by which the respective hinge pins associated with the second side of the lid can be simultaneously extended or retracted with respect to the opposite ends of the lid; and
wherein the user operated linkage control operates the first operating cam to selectively extend or retract the respective hinge pins associated with the first side of the lid, and operates the second operating cam to selectively extend or retract the respective hinge pins associated with the second side of the lid.

3. A hinged lid for an opening in a structure, according to claim 2, wherein the user operated linkage control operates the first operating cam simultaneously with operating the second operating cam.

4. A hinged lid for an opening in a structure, according to claim 3, wherein the user operated linkage control includes a user control cam and linkage linking the user control cam with the first operating cam and with the second operating cam.

5. A hinged lid for an opening in a structure, according to claim 4, wherein the user operated linkage control additionally includes a user control knob by which the user rotates the user control cam.

6. A hinged lid for an opening in a structure, according to claim 5, additionally including a hinge pin housing for slidably holding each hinge pin.

7. A hinged lid for an opening in a structure, according to claim 6, additionally including a spring loaded ball piston for holding the lid in open position when moved to open position.

8. A hinged lid for an opening in a structure, according to claim 6, additionally including spring means for moving a side of the lid to a partially open position when the pins associated with such side are not received by structure pin receiving openings.

9. A hinged lid for an opening in a structure, according to claim 6, wherein the user operated linkage control operates the first operating cam to selectively move the hinge pins associated with the first side of the lid between a fully extended position and a fully retracted position through intermediate positions between the fully extended and fully retracted positions associated with the first side of the lid, and operates the second operating cam to selectively move the hinge pins associated with the second side of the lid between a fully extended position and a fully retracted position through intermediate positions between the fully extended and fully retracted positions associated with the second side of the lid.

10. A hinged lid for an opening in a structure, according to claim 9, wherein the hinged lid is adapted to be positioned with respect to the structure to be moved when hinged to the structure between an open position allowing access to the opening in the structure and a closed position closing the opening in the structure and wherein the hinged lid is adapted, when hinged to the structure, to be in a position with respect to the structure adapted to have either the respective hinge pins associated with the first side of the lid, when in an extended position, received within first structure pin receiving openings aligned with the respective pins associated with the first side of the lid while the respective hinge pins associated with the second side of the lid are not received within structure pin receiving openings, thereby allowing the lid to rotate between open and closed positions about an axis of rotation formed by the respective hinge pins associated with the first side of the lid received within the first structure pin receiving openings or the respective hinge pins associated with the second side of the lid, when in an extended position, received within second structure pin receiving openings aligned with the respective hinge pins associated with the second side of the lid while the respective hinge pins associated with the first side of the lid are not received within structure pin receiving openings thereby allowing the lid to rotate between open and closed positions about an axis of rotation formed by the respective hinge pins associated with the second side of the lid received within the second structure pin receiving openings.

11. A hinged lid for an opening in a structure, according to claim 10, wherein the hinged lid is adapted to be positioned with respect to the structure to be in a position wherein when the respective hinge pins associated with the second side of the lid are in fully retracted position, they are not received within structure pin receiving openings allowing the lid to rotate about the hinge pins associated with the first side of the lid to an open position, to be positioned with respect to the structure to be in a position wherein when the respective hinge pins associated with the first side of the lid are in fully retracted position, they are not received within structure pin receiving openings allowing the lid to rotate about the hinge pins associated with the second side of the lid to an open position, and to be positioned with respect to the structure to be in a position wherein when the respective hinge pins associated with the first side of the lid and associated with the second side of the lid are in middle extended positions they are all received within structure pin receiving openings to thereby lock the lid closed position.

13. A hinged lid for an opening in a structure, according to claim 2, wherein the user operated linkage control operates the first operating cam to move the hinge pins associated with the first side of the lid from the extended position to the retracted position simultaneously with operating the second operating cam to move the hinge pins associated with the second side of the lid from the retracted position to the extended position, and wherein the user operated linkage control moves through a middle intermediate position wherein the respective hinge pins associated with the first side of the lid and the respective hinge pins associated with the second side of the lid are equally extended between the fully retracted position and the fully extended position, wherein the hinged lid is adapted to be positioned with respect to the structure to be move when hinged to the structure between an open position and a closed position and wherein when the lid is in closed position and the user operated linkage control is in the middle intermediate position, the respective hinge pins associated with the first side of the lid and the respective hinge pins associated with the second side of the lid are all received within structure pin receiving openings and the lid is locked in closed position.

14. A hinged lid for an opening in a structure, according to claim 13, wherein the user operated linkage control includes a user control cam and linkage linking the user control cam with the first operating cam and with the second operating cam.

15. A hinged lid for an opening in a structure, according to claim 14, wherein the user operated linkage control additionally includes a user control knob by which the user rotates the user control cam.

16. A hinged lid for an opening in a structure, according to claim 1, wherein the hinged lid is adapted to be positioned with respect to the structure to be moved when hinged to the structure between an open position allowing access to the opening in the structure and a closed position closing the opening in the structure and wherein the hinged lid is adapted, when hinged to the structure, to be in a position with respect to the structure adapted to have either the respective hinge pins associated with the first side of the lid, when in an extended position, received within first structure pin receiving openings aligned with the respective pins associated with the first side of the lid while the respective hinge pins associated with the second side of the lid are not received within structure pin receiving openings, thereby allowing the lid to rotate between open and closed positions about an axis of rotation formed by the respective hinge pins associated with the first side of the lid received within the first structure pin receiving openings or the respective hinge pins associated with the second side of the lid, when in an extended position, received within second structure pin receiving openings aligned with the respective hinge pins associated with the second side of the lid while the respective hinge pins associated with the first side of the lid are not received within structure pin receiving openings thereby allowing the lid to rotate between open and closed positions about an axis of rotation formed by the respective hinge pins associated with the second side of the lid received within the second structure pin receiving openings.

17. A hinged lid for an opening in a structure, according to claim 1, wherein the linkage associated with each of said respective hinge pins by which the respective hinge pins can be extended or retracted with respect to the opposite ends includes:
pin linkage associated with each of said respective hinge pins by which the respective hinge pins can be extended or retracted with respect to the opposite ends;
a first linkage control attached to the lid and attaching the pin linkage associated with the respective hinge pins associated with the first side of the lid by which the respective hinge pins associated with the first side of the lid can be simultaneously extended or retracted with respect to the opposite ends of the lid;
a second linkage control attached to the lid and attaching the pin linkage associated with the respective hinge pins associated with the second side of the lid by which the respective hinge pins associated with the second side of the lid can be simultaneously extended or retracted with respect to the opposite ends of the lid; and
wherein the user operated linkage control operates the first linkage control to selectively extend or retract the respective hinge pins associated with the first side of the lid, and operates the second linkage control to selectively extend or retract the respective hinge pins associated with the second side of the lid.

18. A hinged lid for an opening in a structure, according to claim 1, additionally including a hinge pin housing for slidably holding each hinge pin.

19. A hinged lid for an opening in a structure, according to claim 1, additionally including apparatus for holding the lid in open position when moved to open position.

20. Hinge apparatus for hinging a hinged device to a structure for rotational movement of the hinged device with respect to the structure, wherein the structure includes structure pin receiving openings for rotatably receiving hinge pins therein, comprising:
a plurality of hinge pin housings, each hinge pin housing adapted to slidably receive a hinge pin therein, the hinge pin housings of the plurality of hinge pin housings adapted to be attached to the hinged device in pairs with the hinge pins of each hinge pin housing of a pair aligned to define an axis of rotation of the hinged device with respect to the structure;
a plurality of hinge pins, a hinge pin of the plurality of hinge pins adapted to be slidably received in each hinge pin housing;
a plurality of linkage controls adapted to be attached to the hinged device, a linkage control for each pair of hinge pin housings;
a plurality of pin links, each pin link adapted to link a hinge pin to a linkage control in a manner adapted to simultaneous move hinge pins received in a pair of hinge pin housings between extended or retracted positions with respect to the hinge pin housings;
a user operated linkage control for controlling operation of the linkage controls by a user adapted to be mounted on the hinged device to be available for operation by a user in a manner to cause selectable extension or retraction of hinge pins with respect to a hinge pin housing.
